(19) United States
(12) Patent Application Publication
(10) Pub. No.: US 2021/0140391 A1
(43) Pub. Date: May 13, 2021

(54) SYSTEM AND METHOD FOR INTERNAL COMBUSTION ENGINE WASTE HEAT RECOVERY

(71) Applicant: BorgWarner Inc., Auburn Hills, MI (US)

(72) Inventor: Frederick M. HUSCHER, HENDERSONVILLE, NC (US)

(21) Appl. No.: 16/074,209

(22) PCT Filed: Jan. 26, 2017
(86) PCT No.: PCT/US2017/015069

§ 371 Date: Jul. 31, 2018

Related U.S. Application Data
(60) Provisional application No. 62/289,595, filed on Feb. 1, 2016.

(51) Int. Cl. F02G 5/02; F02B 39/10; F02B 37/10

(52) U.S. Cl. CPC F02G 5/02; F02B 37/10; F02B 39/10

(57) ABSTRACT

A number of variations may include a system which may include an electrified turbocharger along with a waste heat recovery system which may have at least a first boiler operably coupled to a vehicle engine system in order to recover waste heat therefrom. The waste heat recovery system may additionally include at least one waste heat recovery expander. The waste heat recovery system may be operably coupled to a turbocharged system which may have at least one electrified turbocharger. The electrified turbocharger and the waste heat recovery expander may be electrically coupled to a single electric machine.

### CROSS-REFERENCE TO RELATED APPLICATIONS

This application claims the benefit of U.S. Provisional Application No. 62/289,595 filed Feb. 1, 2016.

### TECHNICAL FIELD

The field to which the disclosure generally relates to includes internal combustion engine waste heat recovery systems and methods of making and using the same.

### BACKGROUND

Vehicles may be operated in such a way which may produce engine waste heat.

### SUMMARY OF ILLUSTRATIVE VARIATIONS

A number of variations may include a system which may include a waste heat recovery system having at least a first boiler operably coupled to a vehicle engine system in order to recover waste heat therefrom. Additionally, the waste heat recovery system may include at least one waste heat recovery expander. Moreover, the waste heat recovery system may be operably coupled to a turbocharger system which may have at least one electrified turbocharger. Finally, the electrified turbocharger and the waste heat recovery expander may be electronically coupled to an electric machine.

Other illustrative variations within the scope of the invention may include a method first providing a waste heat recovery system which may be operably coupled to at least one turbocharger. Additionally, the waste heat recovery system may include at least one waste heat recovery expander. The turbocharger and the waste heat recovery system may be operably coupled to a single electric machine. Next, waste heat may be recovered from the waste heat recovery system using at least a first boiler which may be operably coupled to a vehicle engine system. Finally, the recovered waste heat may be used to off load the waste heat recovery expander and additionally may be used to drive the turbocharger.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a system according to a number of variations; and

FIG. 2 is a schematic illustration according to a number of variations wherein the waste heat recovery turbine is integral with the electrified turbocompounding generator.

### DETAILED DESCRIPTION OF ILLUSTRATIVE VARIATIONS

The following description of the variations is merely illustrative in nature and is in no way intended to limit the scope of the invention, its application, or uses.

A number of variations may include a system 10 which may include a waste heat recovery system 14 having at least a first boiler 50 which may be operably coupled to a vehicle engine system 40 in order to recover waste heat therefrom. The waste heat recovery system 14 may additionally include at least one waste heat recovery expander 82. Additionally, a turbocharger system 18 may be provided wherein the waste heat recovery system may be operably coupled to the turbocharger system 18. Additionally, the turbocharger system 18 may include at least one electrified turbocharger 12. Finally, the electrified turbocharger 12 and the waste heat recovery expander 82 may be electrically coupled to a single motor 16.

A number of variations as illustrated in FIGS. 1-2 may include the system 10 which may include the waste heat recovery system 14.

Moreover, the vehicle engine system 40 may be provided and may include an air charge line 30 which may be operatively connected to the compressor 20 of the turbocharger 12. Moreover, an air charger cooler 32 may be provided in the air charge line 30. Additionally, an air charger cooler bypass line 34 may be included in the engine system and may have at least one valve 36 therein. Additionally, the air cooler bypass line 34 may be constructed and arranged so at least a portion of the fluid flowing through the air charge line 30 may bypass the air charger cooler 32 when desired.

Additionally, an air intake manifold 38 may be operatively connected to the air charge line 30. The air intake manifold 38 may be constructed and arranged to provide air flow into a plurality of combustion chambers 42 of a vehicle engine 40. Moreover, an exhaust manifold 44 may be operatively connected to the engine 40 and may receive exhaust expelled from the plurality of combustion chambers 42 of the vehicle engine 40. Additionally, an exhaust conduit 47 may be provided between the exhaust manifold 44 and an exhaust gas recirculation valve 46. A high pressure exhaust gas recirculation loop line 48 may be connected to the exhaust gas recirculation valve 46.

Moreover, the first boiler 50 of the waste recovery system 14 may be provided in the high pressure exhaust gas recirculation loop line 48. The first boiler 50 may include an inlet 56 for working fluid of the waste heat recovery system 14 to enter the first boiler 50 and furthermore may include an outlet 58 for the working fluid to exit the first boiler 50. Moreover, a waste heat recovery first boiler bypass line 52 may be provided and may include a valve 54 therein. The waste heat recovery first boiler bypass line valve 54 maybe constructed and arranged to allow at least a portion of the exhaust flowing through the high pressure exhaust gas recirculation loop line 48 to bypass the first boiler 50 when desired. Moreover, the high pressure exhaust gas recirculation loop line 48 may be connected from the first boiler 50 and bypass line 52 to the air intake manifold 38 in a direct or indirect fashion.

An exhaust conduit 45 may extend from the exhaust gas recirculation valve 46 to the turbine 22 of the turbocharger 12. Exhaust from the turbine 22 may exit through an exhaust line 49 and into a second boiler 62. The second boiler 62 may be operatively connected to the exhaust line 49. Additionally, it is contemplated that the second boiler 62 may include an inlet 64 which may allow the working fluid from the waste heat recovery system 14 to enter the second boiler 62. It is contemplated that the working fluid may enter the second boiler 62 through a conduit 71. Additionally, the second boiler 62 may include an outlet 66 which may allow the working fluid to exit the second boiler 62. It is contemplated that conduit 73 may be connected from the outlet 66 of the second boiler 62. Additionally, an additional exhaust line 51 may be operatively connected to the second boiler 62 and may be constructed and arranged to discharge exhaust into the atmosphere. If desired by a user, a low pressure exhaust gas recirculation loop may be connected to the exhaust line 51 and to the air intake line 30. An aftertreatment system 81 may be provided upstream of the second boiler 62.

A working fluid line 96 may be connected to a condenser 90 which may include a cooling fluid inlet line 92 and a cooling fluid outlet line 94. Moreover, the working fluid line 96 may be connected from the condenser 90 to pump 98 which may be constructed and arranged to increase a pressure of the working fluid. A working fluid line 100 may be connected to the pump 98 and may be additionally connected to a three way valve 68 which may control the flow of working fluid through the working fluid line 70 entering into the first boiler 50. It is additionally contemplated as illustrated in FIG. 2, that the working fluid line 100 may be operably connected directly to the first boiler 50.

It is contemplated that a controller 102 may be provided. The controller 102 may be constructed and arranged to receive input signals 104 from plurality of sensors including but not limited to a sensor 108 on the engine 40, a sensor 110 on the compressor 20, a sensor 112 in one of the working fluid lines for example 96, or a sensor in any other part of the vehicle engine system 40 or waste heat recovery system 14. The controller 102 may be constructed and arranged to send an output signal 106 which may control one or more components of the vehicle system 10.

It is contemplated that the electrified turbocharger 12 may be included in the vehicle engine system 40. As illustrated in FIGS. 1 and 2, the electrified turbocharger 12 may include an additional turbine stage which may be coaxially located on the main turbocharger shaft. This may allow for the inclusion of an electrified turbocharger 12 on vehicles which include waste heat recovery systems 14 using a working fluid and rotary expander 82. It is contemplated that the waste heat recovery system 14 turbine stage could be hermetically sealed and magnetically coupled to the shaft 120. This may eliminate potential for cross contamination between the turbocharger 12 and the working fluid. It is contemplated that the waste heat recovery system 14 may produce most of the energy while the vehicle is at a steady state. It is contemplated that the waste heat recovery system 14 may remain largely unaffected by transient states due to the high thermal inertia of the system. The electrified turbocharger system 12 may have a benefit to the energy during transient states including but not limited to extreme corners of the load speed steady state map. However, the electrified turbocharger system 12 may also assist and generate energy during steady state or engine transients.

It is contemplated that because of the thermal inertia of the waste heat recovery system 14 additional energy from the waste heat recovery system 14 may be available during high load transients which may be short in duration. This energy may be consumed directly by the compressor 20 without electrical losses. Moreover, in times of excess energy in the waste heat recovery system 14, the excess energy may be used to off load the turbocharger turbine 22 and power the turbocharger compressor 20 instead of being bypassed to avoid turbine over speed. It is contemplated that the waste heat recovery system turbine 22 may be coupled with an electrical turbo compound turbine generator 122. This could be used in applications which include engine architectures which do not use exhaust gas recirculation and may eliminate the exhaust gas recirculation boiler or need for waste heat recovery components close to the engine. The waste heat recovery turbine expander 82 may additionally or alternatively be placed outside of an underhood envelope which may free additional space. Further, the waste heat recovery turbine 122 may be placed as close to a tail pipe heat exchanger as possible which may minimize parasitic heat losses from the largest heat source of the vehicle engine system.

It is contemplated as illustrated in FIGS. 1 and 2, that the vehicle system 10 may include the electrically assisted turbocharger 12 and a turbine waste heat recovery system expander 82 in a common package which may use a common electric machine or motor 16. The electric machine or motor 16 may be used to assist the turbocharger compressor stage, harvest waste heat from the exhaust stream, or through the waste heat recovery system working fluid. When the waste heat recovery system 14 has excess energy available, the integral waste heat recovery turbine 22 may off load the exhaust driven turbine in order to drive the turbocharger compressor 20. It is contemplated that the electrified turbocharger 12 and the waste heat recovery system expander 82 may be both electrically coupled to a common motor 16 or generator.

It is contemplated that the waste heat recovery system expander 82 may be constructed and arranged to produce shaft work. The waste heat recovery system expander 82 may include an expander fan wheel which may be connected to a shaft of an electrical generator or motor 16. The electric generator or motor 16 may produce electricity which may be delivered to a converter if necessary and then may be stored in a battery. A battery charge controller may be provided to control the timing rate and perimeters of the charging of the battery. An electrical outlet line may be connected to the battery and to at least one waste heat recovery system pump 98, a condenser coolant pump, or other component as known by one of ordinary skill in the art to selectively supply power thereto.

In a number of variations, the controller 102 or other devices may be used to determine a rapid increase in the load demand on the engine. A rapid increase in the load demand on the engine may occur in transit conditions which may include but are not limited to when the vehicle operator rapidly depresses the accelerator to speed up the vehicle to pass another vehicle, for rapid lane change or for similar situations as known by one of ordinary skill in the art. In order to reduce turbocharger lag and/or more rapidly respond to the vehicle operator demand the controller 102 or other device may cause the three way valve 78 to move so that at least a portion of the working fluid may bypass the waste heat recovery expander 82 and flow to the turbocharger assist turbine 26 in order to rotate the turbocharger assist turbine. It is contemplated that the turbocharger assist turbine 26 may assist in a rotation of the compressor 20 which may charge more inlet gas into the engine 40 which may in turn produce more power from the engine 40.

In a number of variations working fluid of the waste heat recovery system 14 may include but is not limited to at least one of ethanol, water, toluene, methanol, or other refrigerants as known by one of ordinary skill in the art.

In a number of variations the controller 102 may be an electronic control module which may be connected to a plurality of vehicle components including but not limited to the engine 40, the motor 16, a mechanical energy recovery component and a thermal energy recovery. The controller 102 may include hardware and software which may be constructed and arranged to control the components including the components of the waste heat recovery system 14 and the vehicle engine system 40. It is also contemplated that a second electronic control module may be provided to control the operation of one or more components in the vehicle. The second electronic control module may include hardware and software which may be constructed and arranged to carry out a variety of operating processes associated with the components.

The electronic control module and the second electronic control module may each receive and process input from various sensors and transmit output signals to various actuators. The electronic control module and the second electronic control module may be operated independently of one another or one of the electronic control module and/or the second electronic control module may be a slave to either the electronic control module or the second electronic control module in at least some operations and process control situations. The electronic control module and second electronic control module may include an electrical circuit, an electric circuit or chip and/or a computer. In an illustrative variation wherein the electronic control module and second electronic control module include a computer, the electronic control module and secondary electronic control module each generally may include one or more processors, memory devices that may be coupled to the processors and one or more interfaces coupling the processors to one or more other devices. It is contemplated that the processors and other powered system devices may be supplied with electricity by a power supply. The power supply may be one or more of a battery fuel cell or similar power supplies as known by one of ordinary skill in the art. The processors may execute instructions that may provide at least some functionality for the disclosed system and/or methods.

As used herein, the term instructions may include, but are not limited to, control logic, computer software and/or firmware, programmable instructions, or other suitable instructions. The processor may include, for example, one or more microprocessors, microcontrollers, application specific integrated circuits, programmable logic devices, field programmable gate arrays, and/or any other suitable type of electronic processing devices. The memory device may also be configured to provide storage for data received by or loaded to the engine system, and/or for processor executable instructions. The data and/or instructions may be stored, for example, as lookup tables, formulas, algorithms, maps, models, and/or any other suitable format.

The memory may include RAM, ROM, EPROM, and/or any other suitable type of storage article and/or device. Additionally, the interfaces may include analog, digital or digital analog converters, signal conditioners, amplifiers, filters, other electronic devices or software modules, and/or any other suitable interfaces. The interfaces make and form to, for example, RS232, parallel, small computer system interface, universal serial bus, CAN, MOST, LIN, flex ray, and/or any other suitable protocols. Moreover, the interfaces may include circuits, software, firmware, or any other device to assist or enable the ECM and the SECM each in communicating with other devices.

The methods or parts thereof may be implemented in a computer program product including instructions carried out on a computer readable medium for use by one or more processors in order to implement one or more of the method steps. The computer program product may also include one or more software programs comprised of program instructions and source code, object code, executable code, or other formats; one or more firmware programs; or hardware description language files; and any program related data. The data may include data structures, lookup tables, or data in any other suitable format. The program instructions may include program modules, routines, programs, objects, components, etc. The computer program may be executed on processor or in multiple processors in communication with one another.

The programs can be embodied on a computer readable media, which can include one or more storage devices, articles of manufacturer, etc. Illustrative computer readable media include computer system memory, RAM, ROM, semi-conductor memory, electronically erasable programmable read-only memory, flash memory, magnetic or optical discs or tapes, etc. The computer readable medium may also include computer to computer connections, for examples, when data is transferred or provided over a network or other communications network whether wired, wireless or a combination thereof. Any combination of the above examples is also included within the scope of computer readable media. It is therefore to be understood that the method may be at least partially performed by any electronic articles and/or devices capable of executing instructions corresponding to one or more steps of the disclosed methods.

Empirical models may be developed from controlling the operation of one or more of the various components including but not limited to the waste heat recovery system, the turbocharger assist turbine along with EGR loops and components thereof and the engine or engines. The engines may include look up tables maps or other references that may cross-reference cylinder pressure with oxygen concentration. As used herein, the term model may include any construct that represents something using variables such as look up table map formula algorithm or other representation as known by one of ordinary skill in the art. Models may be application specific and particular to the exact design and performance specifications of any given engine system.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a system which may include an electrified turbocharger along with a waste heat recovery system. The waste heat recovery system may include at least a first boiler which may be operably coupled to a vehicle engine system in order to recover waste heat therefrom and may further include at least one waste heat recovery expander. The waste heat recovery system may be operably coupled to a turbocharged system having at least one electrified turbocharger. The electrified turbocharger and the waste heat recovery expander may be electrically coupled to a single motor.

Variation 2 may include a system as set forth in variation 1 wherein the waste heat recovery system is an organic Rankine cycle.

Variation 3 may include a system as set forth in any of variations 1 or 2 wherein the first boiler may be connected to a high pressure EGR loop which may be connected to an engine of the vehicle engine system.

Variation 4 may include a system as set forth in any of variations 1 to 3 wherein the working fluid is an organic working fluid.

Variation 5 may include a system as set forth in any of variations 1 to 4 wherein the working fluid may provide turbocharger assist energy.

Variation 6 may include a system as set forth in any of variations 1 to 5 wherein the electric machine may be used to assist a turbocharger compressor stage, harvest waste heat from the exhaust stream or from the working fluid.

Variation 7 may include a system as set forth in any of variations 1 to 6 wherein the waste heat recovery turbine may off load the exhaust driven turbine in order to drive the turbocharger compressor.

Variation 8 may include a method which may include providing a waste heat recovery system which may be operably coupled to at least one turbocharger and may include at least one waste heat recovery expander. The turbocharger and the waste heat recovery system may be operably coupled to a single electric machine. The waste heat may be recovered from the waste heat recovery system using at least a first boiler and working fluid which may be operably coupled to a vehicle engine system. Finally the recovered waste heat may be used to off load the turbocharger turbine and drive boost device compressor stage.

Variation 9 may include the method as set forth in variation 8 wherein the waste heat recovery system is an organic Rankine cycle.

Variation 10 may include the method as set forth in any of variations 8 to 9 wherein the working fluid is an organic working fluid.

Variation 11 may include the method as set forth in any of variations 8 to 10 wherein the electric machine is a motor.

Variation 12 may include the method as set forth in any of variations 8 to 11 wherein the electric machine is a generator.

Variation 13 may include the method as set forth in any of variations 8 to 12 wherein the electric machine assists the boost device, or harvests waste heat from either or both of the exhaust stream or working fluid.

Variation 14 may include the method as set forth in any of variations 8 to 13 wherein the first boiler is connected to a high pressure EGR loop which may be connected to an engine of the vehicle system.

The above description of select variations within the scope of the invention is merely illustrative in nature and, thus, variations or variants thereof are not to be regarded as a departure from the spirit and scope of the invention.

1. A system comprising:
a waste heat recovery system having at least a first boiler operably coupled to a vehicle engine system in order to recover waste heat therefrom; and
wherein the waste heat recovery system includes at least one waste heat recovery expander operably coupled to a turbocharger system, and wherein the turbocharger and the waste heat recovery expander are electrically coupled to an electric machine, wherein the waste heat recovery system is an organic Rankine cycle.

2. The system of claim 1 wherein the turbocharger comprises a compressor, and wherein the expander is constructed and arranged to produce shaft work.

3. The system of claim 1 wherein the first boiler may be connected to a high pressure EGR loop which may be connected to an engine of the vehicle engine system.

4. The system of claim 1 wherein the working fluid is an organic working fluid.

5. The system of claim 1, wherein the working fluid provides turbocharger assist energy.

6. The system of claim 1, wherein the electric machine may be used to assist a turbocharger compressor stage, harvest waste heat from the exhaust stream or from the working fluid.

7. The system of claim 1, wherein the waste heat recovery turbine may off load the exhaust driven turbine in order to drive the turbocharger compressor.

8. A method comprising:
providing a waste heat recovery system operably coupled to at least one turbocharger and having at least one waste heat recovery expander, wherein the turbocharger and the waste heat recovery system are operably coupled to a single electric machine;
recovering waste heat from the waste heat recovery system using at least a first boiler and working fluid; and
using the recovered waste heat from the waste heat recovery expander to off load the turbocharger turbine and drive a boost device compressor stage, wherein the waste heat recovery system is an organic Rankine cycle.

9. The method of claim 8 wherein the turbocharger comprises a compressor, and wherein the expander is constructed and arranged to produce shaft work.

10. The method of claim 8 wherein the working fluid is an organic working fluid.

11. The method of claim 8 wherein the electric machine is a motor.

12. The method of claim 8 wherein the electric machine is a generator.

13. The method of claim 8 wherein the electric machine assists the boost device, or harvests waste heat from either or both the exhaust stream or working fluid.

14. The method of claim 8 wherein the first boiler is connected to a high pressure EGR loop which may be connected to an engine of the vehicle system.

15. The product as set forth in claim 1 wherein the electric machine comprises a shaft and wherein the expander is coupled to the shaft of the electric machine to produce shaft work.

16. The product as set forth in claim 1 wherein the system comprises an engine and an engine inlet line connected to the engine, an engine exhaust line connected to the engine, and an exhaust gas recirculation line connected to the engine exhaust line and the engine inlet line, and wherein the first boiler in the exhaust gas recirculation line.

17. The product as set forth in claim 1 wherein the turbocharger comprises a turbine connected to an engine exhaust line, a turbine outlet exhaust line connected to the turbine and open to the atmosphere, wherein the first boiler in the turbine outlet exhaust line.

18. The product as set forth in claim 1 wherein the system comprises an engine and an engine inlet line connected to the engine, an engine exhaust line connected to the engine, and an exhaust gas recirculation line connected to the engine exhaust line and the engine inlet line, and the first boiler in the exhaust gas recirculation line, wherein the turbocharger comprises a turbine connected to the engine exhaust line, a turbine outlet exhaust line connected to the turbine and open to the atmosphere, waste heat recovery system comprises a second boiler in the turbine outlet exhaust line.
